(19) United States
(12) Patent Application Publication
(10) Pub. No.: US 2012/0265810 A1
(43) Pub. Date: Oct. 18, 2012

(54) METHOD AND SYSTEM FOR NETWORK-BASED COLLABORATION

(75) Inventors: Chris Reid, Glasgow (GB); Xiaofeng Wang, Glasgow (GB); Lykourgos Petropoulakis, Midlothian (GB); Stephen Behan, Glasgow (GB)

(73) Assignee: Appshare Limited, Glasgow (GB)

(21) Appl. No.: 13/263,896

(22) PCT Filed: Apr. 15, 2010
(86) PCT No.: PCT/GB2010/050622

§ 371 Date: Jan. 6, 2012

(30) Foreign Application Priority Data
Apr. 16, 2009 (GB) 0906557.4

(51) Int. Cl. G06F 15/16

(52) U.S. Cl. 709/204

(57) ABSTRACT

A method and system for establishing a network-based collaboration is described. The method involves the provision of a server-terminal as a data source for the collaboration session, a plurality of client-terminals to allow a user access for participating in the collaboration session and one or more application gateways, the application gateways being configured to relay data between network components during the collaboration session. Both the server-terminal and the client-terminals are allocated an application gateway to which it transmits/and receives data during the collaboration session, the allocation of the application gateways being determined by the location of the server-terminal and client terminals within the network. Also described is a method of data path optimisation for the application gateways employed within the network-based collaboration. A particular application of the present invention is found within the field of Wide Area Network (WAN)-based collaborations.

The present invention relates to data communication and in particular to a method and system for establishing a network-based collaboration. Also described is a method of data path optimisation employed within an established network-based collaboration. A particular application of the present invention is found within the field of Wide Area Network (WAN)-based collaborations.

The term collaboration relates to the sharing of computer resources, and in particular desktop computer resources, across a network.

Recently, collaboration has become more widely employed across networks due to the cost and time savings achieved by avoiding the need for participants to travel between sites to attend meetings in person. A number of collaboration systems are commercially available, for example the system marketed and licensed by:
WebEx Communications, Inc. under the trade mark WebEx;
Citrix Systems, Inc. under the trade mark GoToMeeting;
Microsoft Corporation under the trade mark SharedView;
IBM Corporation under the trade mark Sametime; and
Adobe Systems, Inc. under the trade mark Adobe Acrobat Connect Professional.

A schematic representation of these systems is provided in FIG. 1 and generally depicted by reference numeral 1. These systems are typically based on the use of a central server 2 and any individual wishing to participate in the collaboration session must establish a connection 3 via a computer terminal to the central server 2. The connections 3 to the central server 2 are typically achieved via the Internet 4. Even though many participants may be located within the same site or building 5, if not the same room, one connection 3 is required per computer terminal. In other words, for n computer terminals, the central server 2 must maintain n connections 3.

This approach is known to work well for a small number of participants, but is limited in its scalability and in many cases may not allow for use by hundreds of participants (or greater numbers). In practice, a bottleneck for such a collaboration system 1 exists: any site or building 5 will have an upper bound to its available bandwidth to the outside world. Thus, if the number of participants in a given site 5 is large, then the connection to the outside world becomes choked and the collaboration system 1 becomes, for all intents and purposes, impracticable.

Internet protocol (IP) multicasting is a network-based communication technique that allows for a server to transmit information to multiple computer terminals over an IP infrastructure e.g. streaming media and Internet television applications. It readily scales to a larger receiver population because it does not require any prior knowledge of whom, or how many computer terminals, are receiving the transmitted information. Typically, an IP multicasting system requires the server to send datagrams only once into the network infrastructure, even if the datagrams need to be delivered to a large number of computer terminals. The nodes in the network take care of replicating the datagrams so that they reach the multiple computer terminals. The most common low-level protocol to employ multicast addressing is user datagram protocol (UDP). By its nature, UDP is bandwidth efficient, however it is not reliable since information is often lost or delivered out of order.

The problem of network congestion has previously been recognised in the field of Internet protocol (IP) multicasting. For example, US Patent Publication US2006/0029092 A1 in the name Microsoft Corporation describes a method of transmission optimisation for an application-level multicast. In the described method, for each member of a video conference, a multicast tree is generated that represents a data communication configuration of the data source and the other members of the video conference (i.e. data recipients that receive video and audio data from the data source). An end-to-end transmission delay from each data source to each of the respective data recipients is then determined, as well as the available bandwidth between each data source and the respective data recipients. One or more of the multicast trees, each corresponding to a data source, are then refined according to the end-to-end transmission delay and available bandwidth for a particular data source so as to optimise the data communication configuration of the data source in the video conference.

The described method of US Patent Publication No. US200610029092 A1 employs a number of features which would limit its capabilities if employed within a collaboration system. In the first instance, the described method is limited in its scalability. It requires each member of the application-level multicast to determine bandwidth and delay with all other members. Since this is a full-mesh configuration process, the complexity (and thus the effort) is ½n (n+1), where n is the number of members. This process is repeated for each additional member and so the method quickly becomes unmanageable when n is large. Any collaboration system based on the described method would spend more time and bandwidth on testing connections than actually performing useful data communication.

A second fundamental problem with incorporating the described method of US200610029092 A1 into a collaboration system relates to the fact that the described method has no mechanism through which selected data can be sent directly between individual members of the application-level multicast. Information transmitted by any particular member is sent to all the other members of the application-level multicast.

US Patent Publication No. US200710086366 A1 also in the name Microsoft Corporation describes an alternative system and method for implementing an application-level routing protocol for multiparty audio-video conferencing. Here application-level, per-stream routing techniques separately control audio data and video data between conference members hosted on the network. Different audio application-level multicast (ALM) trees are generated by each member, which are dynamically updated according to shortest-path-first selection of data delivery paths, and these paths are employed to send audio data to the other members of the video conference. Likewise, different video ALM trees are generated by each member, which are dynamically updated according to broadest-path-first selection of data delivery paths, and these paths are employed to send video data to the other members of the video conference. The separate audio and video ALM trees generated for each member utilise IP multicast in segments of the network in which IP multicast is enabled.

As with US2006/0029092 A1, the described protocol of US2007/0086366 A1 comprises a number of inherent features which would limit its utility within a collaboration system. In the first instance, the described protocol employs IP multicast where this is available, and in such an implementation it is not capable of delivering reliable data. The issue of data reliability is further compromised by the dynamic nature of the protocol; the network constantly reorganises which, in practice, leads to an unstable system. The instability of the system is exacerbated by the growth of the number of members wishing to participate in the multiparty audio-video conference. Finally, the described protocol has no mechanism by which selected data can be sent directly between selected individual members. Any audio or visual data sent by a particular member is transmitted to every other member included within the associated audio and video ALM trees.

U.S. Pat. No. 7,315,516 in the name Ghizi Soft Co Limited teaches of a method for generating relay paths amongst a plurality of participants in an application-level multicast, so as to allow for the transmission of predetermined data to the participants. The method involves generating a binary tree structure of relay paths starting from a gateway having relatively fewer hops towards a gateway having relatively more hops.

There are several shortcomings of the described method which again would limit its suitability for use within a collaboration system. In the first instance the method does not take account of actual link speeds. As a result, a gateway of limited capability will nevertheless become a member in the binary tree structure which has an obvious detrimental effect to the efficiency of the network. This shortcoming is exacerbated by the fact that gateways are arranged in the order in which they join. This means that the first gateway to join will sit at the top of the distribution tree. If this happens to be a gateway of very limited resources, the entire distribution across the tree will be severely affected. The employment of a sub-optimal binary tree configuration is particularly wasteful in the situation where plenty of resources are available and so a much higher ‘fan-out’ could be employed.

As with the previously discussed multicasting systems, the method taught by U.S. Pat. No. 7,315,516 has no mechanisms to facilitate selected data being sent between selected individual participants.

It is therefore an object of an aspect of the present invention to provide a method of establishing a network-based collaboration session that obviates or at least mitigates disadvantages of collaboration sessions described in the prior art.

A second object of an aspect of the present invention is to provide a method of carrying out a network-based collaboration session that obviates or at least mitigates disadvantages of collaboration sessions described in the prior art.

A further object of an aspect of the present invention is to provide a method of data path optimisation for a network-based collaboration that obviates or at least mitigates disadvantages of network optimisation methods described in the prior art.

A yet further object of an aspect of the present invention is to provide a system for establishing a network-based collaboration session that obviates or at least mitigates disadvantages of collaboration systems described in the prior art.

### DEFINITIONS OF TERMS

In the following description a terminal refers to computer hardware connected to a network. A terminal has the functionality to host data as well as perform the function of a network client and/or a server.

A client refers to a module that is run on a terminal in order to allow a user to receive data and so participate in the collaboration. The client may also be capable of providing the terminal with the facility to transmit data e.g. to a server and/or to one or more other clients. A client may be implemented in software or firmware, or a combination of software and firmware.

A server refers to a module that is run on a terminal which provides the data for the collaboration session. The server may also be capable of providing the terminal with the facility to receive data e.g. from one or more clients. A server may be implemented in software or firmware, or a combination of software and firmware.

A client-terminal refers to computer hardware upon which a client is run.

A server-terminal refers to computer hardware upon which a server is run.

An application gateway is a functional module of a terminal which might be implemented in hardware, software, or firmware, or a combination thereof. The primary function of an application gateway is to relay collaboration session data between a server and one or more clients located within the network.

### SUMMARY OF INVENTION

According to a first aspect of the present invention there is provided a method of performing a collaboration session in a network, the method comprising the steps of:
providing a server-terminal as a data source for the collaboration session;
providing a plurality of client-terminals, each client-terminal providing a user with an access point for participating in the collaboration session; and
providing one or more application gateways, each application gateway configured to relay data between network components during the collaboration session;
wherein the server-terminal is provided with a server application gateway to which it transmits data during the collaboration session, the server application gateway determined according to the server-terminal location; and
each client-terminal is provided with a client application gateway from which it receives data during the collaboration session, each client application gateway determined according to the client-terminal location.

The provision of the one or more application gateways may involve the provision one or more predefined terminals to act as application gateways, such application gateways are referred to hereinafter as static application gateways. Alternatively, one or more client-terminal or the server-terminal may be instructed to perform the function of the application gateway. This instruction may occur prior to, or during, the collaboration session. Such application gateways are referred to hereinafter as dynamic application gateways. The collaboration session may also employ a combination of static application gateways and dynamic application gateways. The provision of static or dynamic application gateways (as described in further detail below) avoids the requirement for multiple data connections to the server (i.e. one connection for each client) all transmitting the same data. By determining the server and client application gateways based on the locations of the server-terminal and the client-terminals, respectively (i.e. by determining which application gateway is able to supply the highest data throughput rate to the server-terminal and the client-terminals), the method provides the collaboration session with an architecture that has a greater efficiency for the communication of data. This is particularly advantageous within networks having limited bandwidth data connections e.g. as typically found between sub-networks of a network system.

In some embodiments, the method employs a single application gateway as both a server application gateway and a client application gateway. In other words, data may be transmitted directly from the server-terminal to the application gateway, and on to the client-terminal.

In other embodiments, the method employs different application gateways as the server application gateway and the client application gateways. In other words, data may be transmitted directly from the server-terminal to the server application gateway, relayed to the client application gateways, and on to the client-terminal.

The method may employ multiple client application gateways within the network, to which respective client-terminals are allocated. In this embodiment the server application gateway may relay data to multiple client application gateways. Alternatively, or in addition, a first client application gateway may relay data to a second application gateway, which may then relay data to its respective client-terminals.

The method may comprise the additional step of allocating an application gateway to a server-terminal for the duration of the collaboration session, and/or may comprise allocating an application gateway to each of the plurality of client-terminals for the duration of the collaboration session.

Preferably the step of providing the one or more application gateways comprises deploying one or more static application gateways. Most preferably the application gateways are deployed to provide an optimum data transfer speed to an associated sub-network of identified client-terminals.

Alternatively the step of providing the one or more application gateways comprises deploying one or more of the identified client-terminals as one or more dynamic application gateways. Most preferably the one or more identified client-terminals selected to be deployed as the one or more dynamic application gateways are chosen to provide an optimum data transfer speed to an associated sub-network of identified client-terminals. Employing this method of determining the one or more application gateways provides a means for dynamically establishing the collaboration session.

Most preferably the step of providing the server terminal with a server application gateway is performed by a collaboration establishing control module. It is preferable for the collaboration establishing control module to also perform the step of providing the client-terminal with a server application gateway.

Preferably the collaboration establishing control module comprises a web server. The web server may enable communication between the collaboration establishing control module and the plurality of client-terminals and/or the server-terminal.

Preferably the collaboration establishing control module further comprises a collaboration database employed to retain information about the collaboration session.

It is preferable for the collaboration establishing control module to also comprise a daemon that enables the implementation of background run functions for the collaboration session.

An important point to note is that the collaboration establishing control module provides a means for building, initiating and maintaining the collaboration session without being actively involved in the collaboration session. As a result, the collaboration establishing control module does not constitute a data flow bottleneck within the system.

Preferably the collaboration session is initiated by a user submitting a collaboration session request to the collaboration establishing control module. The session request preferably comprises details of the identities of the participating users of the collaboration session. Supplying details of the participating users assists in maintaining the security of the collaboration session.

Optionally the session request further comprises a scheduled time, T_{c}, for the collaboration session.

Preferably a session identifier is allocated to the collaboration session following the submission of the collaboration request.

Optionally the server-terminal is located outside of the associated sub-network of identified client-terminals.

Most preferably the method of performing a collaboration session in a network further comprises the step of performing a load test on two or more application gateways. The load test may allow for the establishment of an optimised data communication path which further improves the efficiency of the operation of the collaboration session. The load test may be performed by the collaboration establishing control module. Most preferably the optimised data communication path remains established for the duration of the collaboration session.

Optionally, the load test is carried out a predetermined time, Tₚ, prior to the scheduled time, T_{c}, for the collaboration session.

Optionally the predetermined time, Tₚ is determined by the following expression Tₚ=T_{c}−(Tₜₑₛₜ×C) where Tₜₑₛₜ is a time taken to perform a previous load test on the collaboration network and C is an error margin factor. The error margin factor may have a value greater than 1, for example C=1.5.

Preferably the method of performing a collaboration session in a network further comprises the step of each participating client submitting a user registration request to the collaboration establishing control module. The method may further comprise a server submitting a user registration request to the collaboration establishing control module. In order to register with the collaboration session the user registration request may comprise a valid session identifier, a valid user name and password.

Preferably, the load test is performed after the server submits a user registration request to the collaboration establishing control module.

The load test may be in accordance with the fifth aspect of the present invention and its preferred embodiments.

Preferably the user registration request is checked to establish whether or not the user has the required permission to join the collaboration session. Validation of each user further assists in maintaining the security of the collaboration session.

Most preferably, if it is established that the user has the required permission, then the client is allocated a client identifier. The allocation of client identifiers is advantageous since it allows for each of the participating clients to send data directly to each other i.e. this data is not required to be sent to all of the clients employed within the collaboration session.

Preferably the method of establishing the network-based collaboration session further comprises the step of an application gateway providing an indication to the collaboration establishing control module that a client handling capability of the application gateway is, or is about to be, exhausted.

Preferably when a further valid user registration request is received from a client within the associated sub-network the client-terminal submitting the request is instructed to function as a first sub-network dynamic application gateway. In this way any further client within the sub-network that submits a valid user registration request is directed to connect to the collaboration session via the first sub-network dynamic application gateway.

Optionally the first sub-network dynamic application gateway provides an indication to the collaboration establishing control module that a client handling capability of the first sub-network dynamic application is, or is about to be, exhausted.

Preferably when a further valid user registration request is received from a client within the associated sub-network the client-terminal submitting the request is instructed to function as a second sub-network dynamic application. In this way any further client within the sub-network that submits a valid user registration request is directed to connect to the collaboration session via the second sub-network dynamic application gateway.

Preferably the method of performing the collaboration session further comprises the step of one of the plurality of clients selectively transmitting data to the server and/or one or more of the other plurality of clients. The described collaboration session therefore allows for the server and each of the participating clients to send data directly to each other i.e. this data is not required to be sent to all of the clients of the collaboration session. In this way each client can submit session control requests and file upload requests.

Preferably the step of selectively transmitting data comprises the transmission of data to the client application gateway and the subsequent relaying of this data by the client application gateway to the server-terminal and/or the one or more of the plurality of client-terminals.

Most preferably the server-terminal and the server application gateway are located within a first sub-network.

Optionally the client application gateway and at least one of the plurality of client-terminals is located within a second sub-network.

Preferably the network comprises a wide area network and the first and second sub-networks comprise local area networks.

Most preferably the step of transmitting and relaying data comprises the employment of a transmission control protocol/Internet protocol (TCP/IP).

According to a second aspect of the present invention there is provided a network system comprising:
a server-terminal providing a source for data in a collaboration session;
a plurality of client-terminals, each providing a user with an access point for participating in a collaboration session; and
one or more application gateways each application gateway configured to relay data between network components during a collaboration session;
wherein the server-terminal is provided with a server application gateway to which it transmits data during the collaboration session, the server application gateway determined according to the server-terminal location; and
each client-terminal is provided with a client application gateway from which it receives data during the collaboration session, each client application gateway determined according to the client-terminal location.

In some embodiments, a single application gateway may function as both the server application gateway and the client application gateway. In other words, data may be transmitted directly from the server-terminal to the application gateway, and on to the client-terminal.

In other embodiments, the server application gateway and the client application gateway may be different application gateways. In other words, data may be transmitted directly from the server-terminal to the server application gateway, relayed to the client application gateway, and on to the client-terminal.

There may be multiple client application gateways in the network, to which are allocated respective client-terminals. Therefore, the server application gateway may relay data to multiple client application gateways. Alternatively, or in addition, a first client application gateway may relay data to a second application gateway, which may then relay data to its respective client-terminals.

Most preferably the network system further comprises collaboration establishing control module.

Preferably the collaboration establishing control module comprises a web server. The web server may enable communication between the collaboration establishing control module and the plurality of client-terminals and/or the server-terminal.

Preferably the collaboration establishing control module further comprises a collaboration database employed to retain information about the collaboration session.

It is preferable for the collaboration establishing control module to also comprise a daemon that enables the implementation of background run functions for the collaboration session.

Embodiments of the second aspect of the invention may comprise features to implement the preferred or optional features of the first aspect of the invention or vice versa.

According to a third aspect of the present invention there is provided a method of configuring a network for a network-based collaboration session, the network comprising a server and a plurality of clients, the method comprising the steps of:
identifying one or more one sub-networks of terminals within the network; and providing the one or more identified sub-networks with one or more application gateways the one or more application gateways being configured to relay data between network components during the collaboration.

Preferably the step of providing the one or more application gateways comprises deploying one or more static application gateways. Most preferably the application gateways are deployed to provide an optimum data transfer speed to the sub-network of identified terminals.

Alternatively the step of providing the one or more application gateways comprises deploying one or more of the identified terminals as one or more dynamic application gateways. Most preferably the one or more identified terminals selected to be deployed as the one or more dynamic application gateways are chosen to provide an optimum data transfer speed to the sub-network of identified terminals. Employing this method of determining the one or more application gateways provides a means for dynamically establishing the collaboration session.

Most preferably at least one of the terminals is configured as a server-terminal that provides a data source for the collaboration session. Preferably two or more of the terminals are configured as client-terminals to provide a user with an access point for participating in the collaboration session.

The method may comprise the additional step of allocating an application gateway to a server, and/or allocating an application gateway to a plurality of clients.

The method may comprise the additional step of allocating an application gateway to a server for the duration of the collaboration session, and/or may comprise allocating an application gateway to each of the plurality of clients for the duration of the collaboration session.

Most preferably the step of allocating the one or more application gateways to the server and/or the plurality of clients is performed by a collaboration establishing control module.

Preferably the collaboration session is initiated by a user submitting a collaboration session request to the collaboration establishing control module. The session request preferably comprises details of the identity of the participating users of the collaboration session.

Optionally the session request further comprises a scheduled time, T_{c}, for the collaboration session.

Preferably a session identifier is allocated to the collaboration session following the submission of the collaboration request.

Most preferably the method of establishing a network-based collaboration session further comprises the step of performing a load test or throughput test on two or more application gateways. The load test or throughput test is in the form of an analysis of the throughput capacities of the paths connecting the application gateways. In particular the throughput capacity of a predetermined quantity of data in both directions between each site is measured. It is preferable for the predetermined quantity of data to be at least 32 kb in size. The load test may allow for the establishment of an optimised data communication path which further improves the efficiency of the operation of the collaboration session. The load test may be performed by the collaboration establishing control module. Most preferably the optimised data communication path remains established for the duration of the collaboration session.

Optionally the load test is carried out a predetermined time, Tₚ, prior to the scheduled time, T_{c}, for the collaboration session.

Optionally the predetermined time, Tₚ is determined by the following expression Tₚ=T_{c}−(Tₜₑₛₜ×C) where Tₜₑₛₜ is to time taken to perform a previous load test on the collaboration network and C is an error margin factor. The error margin factor may have a value greater than 1, for example C=1.5.

Preferably, the load test is performed after the server submits a user registration request to the collaboration establishing control module.

The load test may be in accordance with the fifth aspect of the present invention and its preferred embodiments.

Preferably the method of establishing a network-based collaboration session further comprises connecting the two or more application gateways to establish a data communication path between two or more sub-networks of identified terminals. Most preferably the data communication path remains established for the duration of the collaboration session.

Preferably the sub-networks comprise local area networks located within a wide area network.

Embodiments of the third aspect of the invention may comprise preferred or optional features of the first aspect of the invention or vice versa.

According to a fourth aspect of the present invention there is provided a method of performing a collaboration session the method comprising the steps of:
configuring a network-based collaboration session in accordance with the third aspect of the present invention; and
communicating data between the server and the plurality of clients via one or more application gateways.

Most preferably the step of communicating data comprises the step of employing a transmission control protocol/Internet protocol (TCP/IP).

According to a fifth aspect of the present invention there is provided a method of determining an optimised data communication path between two or more application gateways employed within a network-based collaboration session to relay data between network components, the method comprising the step of performing a load test or throughput test on the two or more application gateways.

The above method provides a communication data path that is optimised to as to provide the most efficiently arrangement for connecting the two or more application gateways within the network. Most preferably the two or more application gateways remain connected for the duration of the collaboration session.

Most preferably the load test or throughput test comprises the step of measuring throughput capacities or network speeds of data paths, preferably all the data paths, between the application gateways. The load test may comprise measuring bidirectional throughput capacities or network speeds.

Preferably the load test further comprises generating a connectivity matrix from the measured network throughput capacities or speeds.

It is also preferable for the load test to further comprise normalising the connectivity matrix. Normalisation ensures that connections which only slightly differ in their measured throughput capacities or speeds are effectively regarded as having the same throughput capacities or speeds. Without normalisation a “chaining effect” can occur whereby the data communication path tends to grow in depth rather than breadth which results in more end-to-end delay and sub-optimal data transmission.

Optionally the load test further comprises identifying available capacities of the two or more application gateways. Identifying the available capacity of the two or more applications provides the load test with the option of establishing an out of capacity application gateway set.

Preferably the load test further comprises the step of defining an application gateway source set. Most preferably the application gateway source set is initially set to comprise an application gateway to which a server-terminal is to be connected.

Preferably the load test further comprises the step of voiding the column of the normalised connectivity matrix corresponding to the source set.

Preferably the load test further comprises the step of identifying an application gateway, not included within the source set, which has the highest throughput capacities or speed of data path connection with the source set.

Optionally the step of identifying an application gateway further comprises checking that the application gateway which has the highest throughput capacities or speeds of data path connection is not included within the out of capacity application gateway set.

Optionally the step of identifying an application gateway further comprises selecting an application gateway having a smaller hop count from the application gateway to which the server-terminal is connected. This step is required when two or more application gateways are identified as having the same throughput capacities or speeds of data connection with the source set.

Optionally the step of identifying an application gateway further comprises selecting an application gateway having the largest available connection handling capacity. This step is required when two or more application gateways are identified as having the same throughput capacity or speed of data connection with the source set and have an equal hop count from the application gateway to which the server-terminal is connected.

Preferably the load test further comprises the step of adding the identified application gateway to the source set.

Optionally the available connection handling capacity of the identified application gateways is updated.

According to a sixth aspect of the present invention there is provided a system for establishing a network-based collaboration session between a server and a plurality of clients on a network, the system comprising a collaboration establishing control module wherein the collaboration establishing control module provides a means for determining one or more application gateways to be employed in the collaboration session, based on at least one location selected from the location of a server-terminal and the locations of a plurality of client-terminals.

Preferably the collaboration establishing control module comprises a web server that enables the client-terminals to communicate with the collaboration establishing control module. The web server preferably comprises a graphic user interface (WebGUI), a session scheduler and a user authentication module.

Preferably the collaboration establishing control module further comprises a collaboration database employed to retain information about the collaboration session.

It is preferable for the collaboration establishing control module to also comprise a daemon that enables the implementation of background run functions for the collaboration session. The daemon preferably comprises an application gateway interface, a load tester, a path analyser and a routing table module. This structure allows for the establishment of the collaboration session to be implemented within the session layer (layer five) of the OSI reference model.

Most preferably the user authentication module enables authentication of the details of a request from the at least one user to join the collaboration session.

Preferably the session scheduler is employed to receive a collaboration session request from a user wishing to initiate a collaboration session. Preferably the session request comprises details of users invited to the collaboration session. Supplying details of the invited users to the session scheduler assists in maintaining the security of the collaboration session.

Optionally the session request may further comprise a scheduled time for the collaboration session.

Preferably the session scheduler allocates a session identifier to the collaboration session following the submission of the collaboration request.

Preferably the collaboration database stores a pre-assigned group of static application gateways so enabling the collaboration establishing control module to determine the one or more application gateways. Most preferably the selected application gateways are chosen to provide an optimum data transfer throughput capacity or speed to an associated sub-network of client-terminals.

Alternatively the session scheduler is employed to deploying one or more of the client-terminals as one or more dynamic application gateways. Most preferably the one or more identified client-terminals selected to be deployed as the one or more dynamic application gateways are chosen to provide an optimum data transfer throughput capacity or speed to an associated sub-network of client-terminals.

Optionally the server-terminal is located outside of the associated sub-network of client-terminals.

Most preferably the load tester is employed to perform a load test or throughput test on the two or more application gateways. The load test may allow for the determination of an optimised data communication path which further improves the efficiency of the operation of the collaboration session.

Optionally the load test is carried out a predetermined time, Tₚ, prior to the scheduled time, T_{c}, for the collaboration session.

Optionally the predetermined time, Tₚ is determined by the following expression Tₚ=T_{c}−(Tₜₑₛₜ×C) where Tₜₑₛₜ is to time taken to perform the previous load test on the collaboration network and C is an error margin factor. The error margin factor may have a value greater than 1, for example C=1.5.

Preferably, the load test is performed after the server submits a user registration request to the collaboration establishing control module.

The load test or throughput test may be in accordance with the fifth aspect of the present invention and its preferred embodiments.

Most preferably the load tester instructs the path analyser to measure the network speeds of at least some of the data paths between the application gateways. The path analyser may measure bidirectional network speeds, and/or may measure all of the data paths. It is advantageous to the optimisation of the data communication path to take account of bidirectional network speeds since the bandwidth and latency of a data path is dependent on the direction of measurement.

Preferably the load tester stores a connectivity matrix generated from the measured network throughput capacities or speeds within the routing table.

Preferably the load tester provides a means for processing the connectivity matrix stored within the routing table so as to provide an optimised data communication path for the two or more application gateways.

Most preferably the session scheduler provides a means for connecting two or more application gateways to establish a data communication path between associated sub-networks of client-terminals.

Preferably the associated sub-networks comprise local area networks located within a wide area network.

Preferably the user authentication module authenticates the details of a user registration request by checking that it comprises a valid session identifier, a valid user name and password. Validation of each user further assists in maintaining the security of the collaboration session.

Most preferably, if it is established that the user has the required permission then the session scheduler allocates the client with a client identifier and details of the appropriate application gateway for the client to connect to the collaboration session. The allocation of client identifiers is advantageous since it allows for the server-terminal and each of the participating client-terminals to send data directly to each other i.e. this data is not required to be sent to all of the terminals of the collaboration session.

Preferably the application gateway interface provides a means for an application gateway to inform the session scheduler that a client handling capability of the application gateway is, or is about to be, exhausted.

Preferably when the user authentication module receives a further valid user registration request from a client within the associated sub-network the session scheduler instructs the client-terminal submitting the request to function as a first sub-network dynamic application gateway. In this way any further clients within the sub-network that submits a valid user registration request is directed to connect to the collaboration session via the first sub-network dynamic application gateway.

Optionally the application gateway interface provides a means for the first sub-network dynamic application gateway to inform the session scheduler that a client handling capability of the first sub-network dynamic application is, or is about to be, exhausted.

Preferably when the user authentication module receives a further valid user registration request from a client within the associated sub-network the session scheduler instructs the client-terminal submitting the request to function as a second sub-network dynamic application gateway. In this way any further client within the sub-network that submits a valid user registration request is directed to connect to the collaboration session via the second sub-network dynamic application gateway.

Embodiments of the sixth aspect of the invention may comprise the preferred or optional features of the first, third and fifth aspects of the invention, or vice versa.

According to a seventh aspect of the present invention there is provided a method of establishing a network-based collaboration session between a server and a plurality of clients on a network, the method comprising the steps of:
identifying one or more sub-networks of terminals within the network; and
deploying one or more terminals within the one or more identified sub-networks as an application gateway configured to relay data between network components during the collaboration.

The employment of the one or more application gateways avoids the requirement for multiple data connections all transmitting the same data. The deployment of one or more terminals to function as application gateways provides a dynamic architecture that has a greater efficiency for the communication of data. This is particularly advantageous within networks having limited bandwidth data connections e.g. as typically found between sub-networks of a network system.

Most preferably the one or more terminals selected to be deployed as the one or more application gateways are chosen to provide an optimum data transfer speed to the sub-network of identified terminals.

Most preferably at least one of the terminals is configured as a server-terminal that provides a data source for the collaboration session. Preferably two or more of the terminals are configured as client-terminals to provide a user with an access point for participating in the collaboration session.

The method may comprise the additional step of allocating an application gateway to a server, and/or allocating an application gateway to a plurality of clients.

The method may comprise the additional step of allocating an application gateway to a server for the duration of the collaboration session, and/or may comprise allocating an application gateway to each of the plurality of clients for the duration of the collaboration session.

Most preferably the step of allocating the one or more application gateways to the server and/or the plurality of clients is performed by a collaboration establishing control module.

Preferably the collaboration session is initiated by a user submitting a collaboration session request to the collaboration establishing control module.

Optionally the server-terminal is located outside of the one or more sub-networks of identified client-terminals.

Most preferably the method of establishing a network-based collaboration session further comprises the step of performing a load test or throughput test on two or more application gateways. The load test may allow for the establishment of an optimised data communication path which further improves the efficiency of the operation of the collaboration session. The load test may be performed by the collaboration establishing control module. Most preferably the optimised data communication path remains established for the duration of the collaboration session.

Optionally the load test is carried out a predetermined time, Tₚ, prior to the scheduled time, T_{c}, for the collaboration session.

Optionally the predetermined time, Tₚ is determined by the following expression Tₚ=T_{c}−(Tₜₑₛₜ×C) where Tₜₑₛₜ is to time taken to perform the previous load test on the collaboration network and C is an error margin factor. The error margin factor may have a value greater than 1, for example C=1.5.

Preferably, the load test or throughput test is performed after the server submits a user registration request to the collaboration establishing control module.

The load test or throughput test may be in accordance with the fifth aspect of the present invention and its preferred embodiments.

Preferably the method of establishing a network-based collaboration session further comprises connecting the two or more application gateways to establish a data communication path between associated sub-networks of identified terminals. Most preferably the two or more application gateways remain connected for the duration of the collaboration session.

Preferably the associated sub-networks comprise local area networks located within a wide area network.

Embodiments of the seventh aspect of the invention may comprise the preferred or optional features of the first, third, fifth and sixth aspects of the invention, or vice versa.

According to an eighth aspect of the present invention there is provided a method of performing a collaboration session the method comprising the steps of:
establishing a network-based collaboration session in accordance with the seventh aspect of the present invention; and
communicating data between the server and the plurality of clients via one or more application gateways.

Most preferably the step of communicating data comprises the step of employing a transmission control protocol/Internet protocol (TCP/IP). Such a communication protocol provides for the ordered delivery of data and so assists the collaboration session in satisfying the desired security and data delivery reliability requirements.

According to a ninth aspect of the present invention there is provided a computer apparatus loaded with machine readable instructions for implementing a method of performing a collaboration session in a network in accordance with the first aspect of the present invention.

According to a tenth aspect of the present invention there is provided a computer apparatus loaded with machine readable instructions for implementing a method of configuring a network for a network-based collaboration session in accordance with the third aspect of the present invention.

According to an eleventh aspect of the present invention there is provided a computer apparatus loaded with machine readable instructions for implementing a method of performing a collaboration session in accordance with the fourth aspect of the present invention.

According to a twelfth aspect of the present invention there is provided a computer apparatus loaded with machine readable instructions for implementing a method of determining an optimised data communication path between two or more application gateways employed within a network-based collaboration session in accordance with the fifth aspect of the present invention.

According to a thirteenth aspect of the present invention there is provided a computer apparatus loaded with machine readable instructions for implementing a method of establishing a network-based collaboration session between a server and a plurality of clients on a network in accordance with the seventh aspect of the present invention.

According to a fourteenth aspect of the present invention there is provided a computer apparatus loaded with machine readable instructions for implementing a method of performing a collaboration session in accordance with the eighth aspect of the present invention.

### BRIEF DESCRIPTION OF DRAWINGS

While aspects of the described methods and systems for collaboration sessions can be implemented in any number of different computing systems, environments, and/or configurations, embodiments of collaboration sessions are described in the context of the following detailed exemplary system architecture and with reference to the following drawings in which:

FIG. 1 presents a schematic diagram of a prior art collaboration system;

FIG. 2 presents a schematic diagram of a Wide Area Network (WAN) based collaboration session within which the data paths have been optimised in accordance with a method of an embodiment of the present invention;

FIG. 3 presents a block diagram of an exemplary collaboration establishing control module employed within the Wide Area Network-based collaboration session of FIG. 2;

FIG. 4 presents a flow chart of a first methodology employed to establish the collaboration session of FIG. 2;

FIG. 5 presents a schematic diagram showing the deployment of application gateways within the Wide Area Network of FIG. 2;

FIG. 6 presents a schematic representation of a load test carried out between the application gateways within the Wide Area Network of FIG. 2;

FIG. 7 presents a connectivity matrix generated by the load test of FIG. 6;

FIG. 8 presents an exemplary method employed by the collaboration establishing control module to convert the connectivity matrix of FIG. 7 to an optimised data path between the application gateways within the WAN of FIG. 2;

FIG. 9 presents a schematic representation of a client authentication process employed within the collaboration session of FIG. 2;

FIG. 10 (a) to (e) present schematic representations of data routes provided for the transmission of data within the collaboration session of FIG. 2;

FIG. 11 presents a schematic representation of the deployment of a dynamic application gateway within the collaboration session of FIG. 2; and

FIG. 12 presents a flow chart of a second methodology employed to establish the collaboration session of FIG. 2.

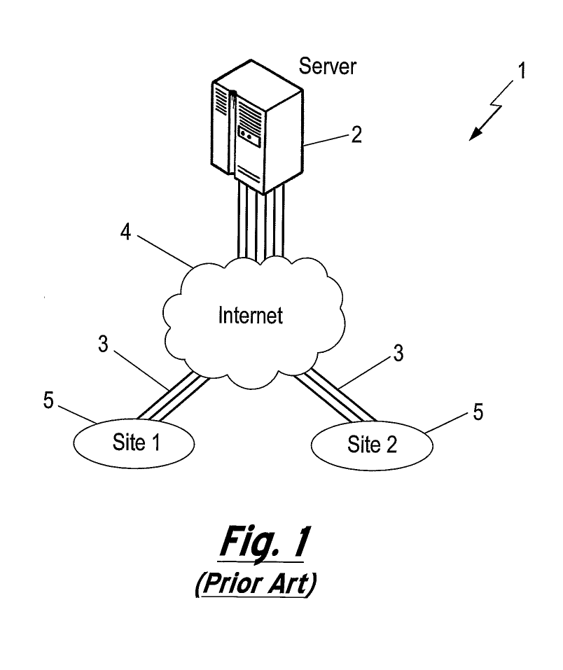

### DETAILED DESCRIPTION

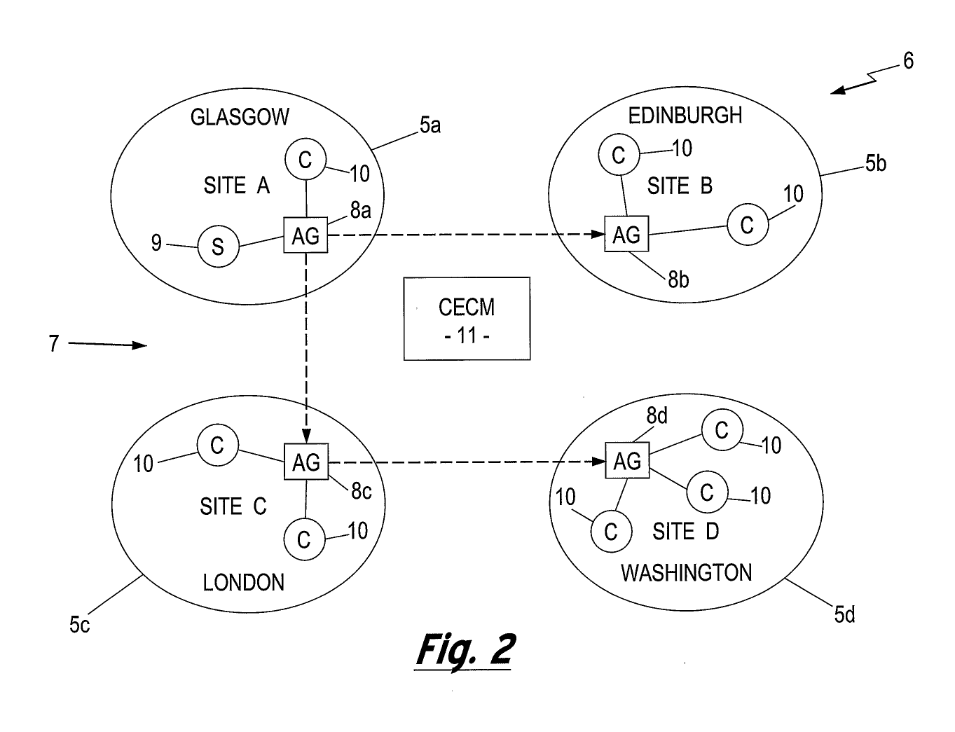

In order to provide understanding of the various aspects of the present invention a collaboration session 6 within a Wide Area Network (WAN) 7 will now be described. A schematic representation of this collaboration session 6 is presented in FIG. 2. In the presently described embodiment, the WAN 7 can be seen to comprise four separate sites 5a, 5b, 5c and 5d each of which comprises a Local Area Network (LAN). For example, sites 5a, 5b, 5c and 5d could be located in Glasgow, Edinburgh, London and Washington, respectively. The sites 5a, 5b, 5c and 5d are connected by means of four application gateways 8a, 8b, 8c and 8d, further details of which are provided below.

Within site 5a is located a server 9 which provides the data source for the collaboration session 6. The server 9 comprises software that is run on a computer terminal (referred to herein after as a server-terminal). The server 9 may also be capable of receiving data.

A number of clients 10 participating within the collaboration are located throughout each of the sites 5a, 5b, 5c and 5d. A client 10 comprises software that is run on a computer terminal (referred to herein after as a client-terminal) in order to allow a user to receive data and so participate in the collaboration session 6. However, it will be understood that the client 10 may also be capable of transmitting data e.g. to the server 9 and/or to one or more of the other clients 10. Further details of the data routing process within the collaboration session 6 is described below.

The adoption of the application gateways 8a, 8b, 8c and 8d solves the problem of multiple connections in and out of the sites 5a, 5b, 5c and 5d, as is required by the previously described prior art systems 11.e. one for each participant in the collaboration. Since data flowing from the server 9 is the same for all the clients 10, it is not necessary to have multiple data streams between the sites 5a, 5b, 5c and 5d. Data can simply be redistributed within the LAN of the sites 5a, 5b, 5c and 5d, thereby greatly reducing the required bandwidth at the potential bottleneck i.e. the physical connection to the outside world.

In addition, since the bandwidth available within the LAN of the sites 5a, 5b, 5c and 5d is typically much greater than across the WAN 7 the adoption of the application gateways 8a, 8b, 8c and 8d provides a much more efficient use of the available network architecture.

The reduced bandwidth requirements within the network also allow the collaboration session 6 to employ a transmission control protocol/Internet protocol (TCP/IP) for the communication of data within the network. This differs from traditional application-level multicast systems which employ a user datagram protocol (UDP) due to bandwidth restrictions. As is known to those skilled in the art, TCP/IP provides for the reliable, ordered delivery of a data stream within a communication system while UDP being a simple transmission protocol without implicit hand-shaking dialogues does not guarantee reliability, ordering, or data integrity. Employing TCP/IP for the communication of data therefore allows the collaboration session 6 to satisfy the desirable security and data delivery reliability requirements.

In the above described example, there is only ever one data stream flowing between the sites 5a, 5b, 5c and 5d. This results in a network architecture that is highly scalable: in this example the server 9 is completely unaware that there are actually eight clients 10, as it only needs to provide data to one application gateway 8a.

As well as saving bandwidth, the optimised network also results in significant conserving of processing power. A very moderate server-terminal (in terms of hardware) can be employed to host the server 9 and effectively serve a multitude of clients 10. This factor becomes more important when not only the hardware is limited, but also the available bandwidth. For example, by adopting such an optimised network it is possible for even a relatively slow connection to serve many clients 10 e.g. from a home or a hotel room.

### Collaboration Establishing Control Module (CECM)

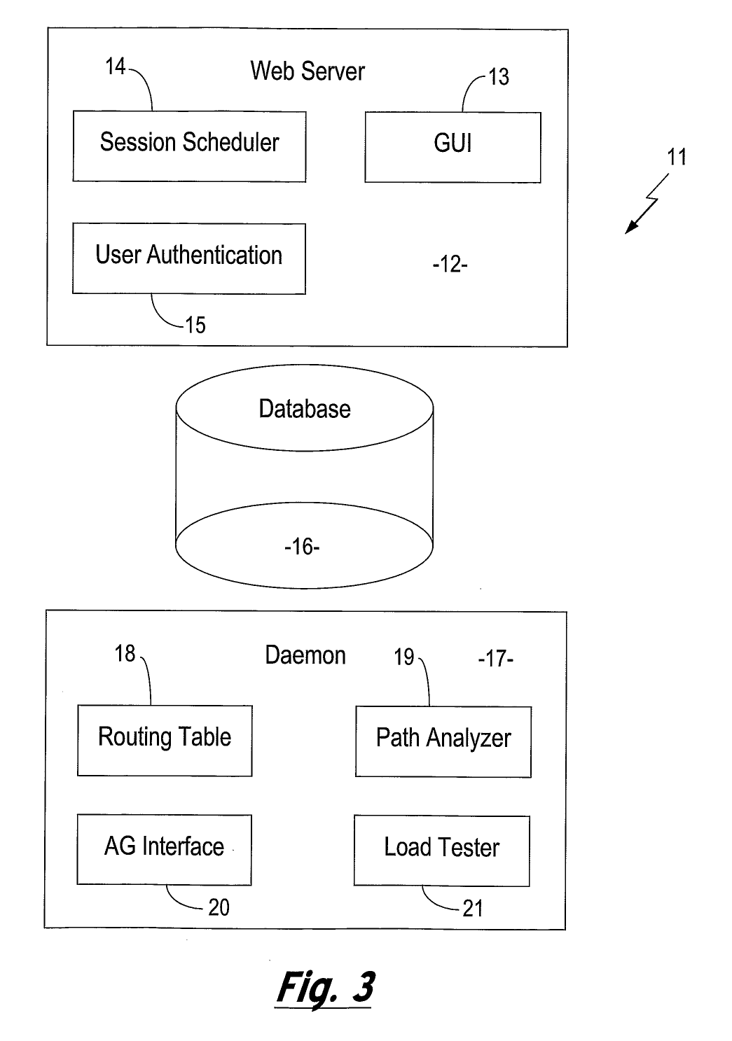

In FIG. 3 a block diagram of a collaboration establishing control module (CECM) 11 is presented. The CECM 11 is the central architecture that allows for the collaboration session 6 to take place. From FIG. 3 the CECM 11 can be seen to comprise three functional components, namely: a web server 12, provided with a graphical user interface (GUI) 13, a session scheduler 14 and a user authentication module 15; a collaboration database 16 employed to retain application gateway data, session data, and client data; and a daemon 17 provided with a routing table 18, a data path analyser 19, an application gateway interface 20 and a load tester 21.

The CECM 11 handles all of the management functions that are required to build, initiate and maintain the collaboration session 6. The web server 12 provides the GUI 13 for the CECM 11, whereas the daemon 17 implements the functions that are run in the background, such as the load testing (details of which are provided below). More specifically, the CECM 11 fulfils the following tasks for the collaboration session 6, namely:
1) Session scheduling;
2) User authentication;
3) Application gateway management; and
4) Session data path calculation.

Further detail of each of these tasks is discussed below.

The CECM 11 may also act as a virtual lobby. For example, the collaboration session 6 might be scheduled, and one or more clients 10 may wish to join prior to the server 9 having joined the session 6. In these circumstances the CECM 11 temporarily acts as an assembly point for these clients 10 and then ‘leads’ all of the clients 10 to the meeting when the server 9 is present and the collaboration session 6 is ready to start.

Significantly however, the CECM 11 is not actively involved in the collaboration session 6, and, therefore, does not constitute a bottlenecking effect as are associated with central servers 2 employed within the prior art systems 1. Furthermore, the CECM 11 acts to abstract the network 7 in terms of addresses. All the server 9, the clients 10, or indeed the application gateways 8 needs to know about the network 7, is the IP address, or a textual alias obtained through the Domain Name System (DNS) e.g. cecm.appshare.co.uk, of the CECM 11.

### Method of Establishing a Collaboration Session Within a Network

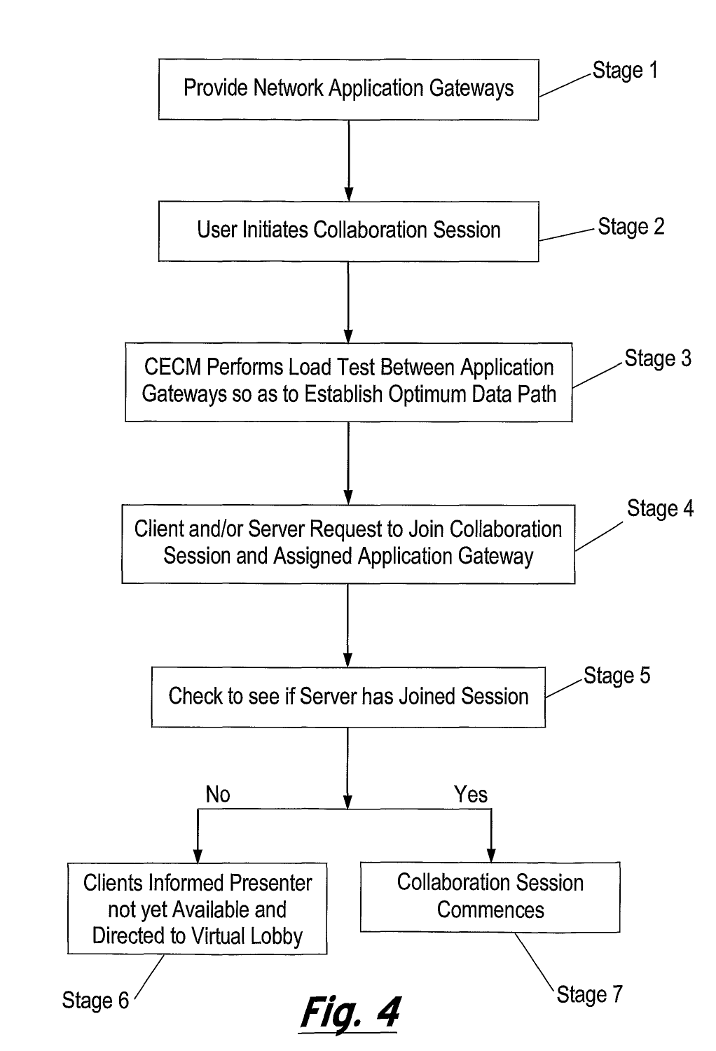

There now follows a discussion on the methodology employed to establish the collaboration session 6 between a plurality of clients 10 within the WAN 7. As will be seen, the method employed to achieve the data path optimisation within the WAN 7 is important in reducing the bandwidth requirements, and hence increasing the efficiency of the collaboration session 6. FIG. 4 presents a flow chart for the described method.

### Stage 1) Provision of Application Gateways

The first stage in establishing the collaboration session 6 within the WAN 7 involves the provision of one or more application gateways 8 within each site 5. As outlined above, the function of the application gateways 8 is to act as an input/output for the LAN of the associated site 5 so as to increase efficiency while maximising the number of clients 10 that can be supported. In the presently described embodiment this involves allocating one or more terminals within the sites 5a, 5b, 5c and 5d to perform the function of the application gateway 8 for that site.

There exist strategic places where the application gateways 8a, 8b, 8c and 8d could, and should, be deployed to optimise performance. Typically, each site 5 will have one or more physical connections to the outside world. Therefore it is found that the closer to the incoming/outgoing physical connection an application gateway 8a, 8b, 8c and 8d is positioned, the more efficiently it will operate. However for the presently described collaboration session what is required is the provision of at least a single application gateway 8 within the sites 5a, 5b, 5c and 5d.

This mode of deployment is hereinafter referred to as the deployment of static application gateways 8. Such static deployment is typically achieved through the employment of continuously run servers.

Once selected, an application gateway, for example gateway 8d, is provided with the IP address of the CECM 11. On start up, the application gateway 8d registers with the CECM 11 via the application gateway interface 20, and the session scheduler 14 then assigns it an application gateway identification, as well as providing it with details of all the other application gateways 8a, 8b and 8c already registered. The CECM 11 also adds the details of the application gateway 8d into the collaboration database 16 and updates any previously registered application gateways 8a, 8b, and 8c with the details of the newly registered application gateway 8d.

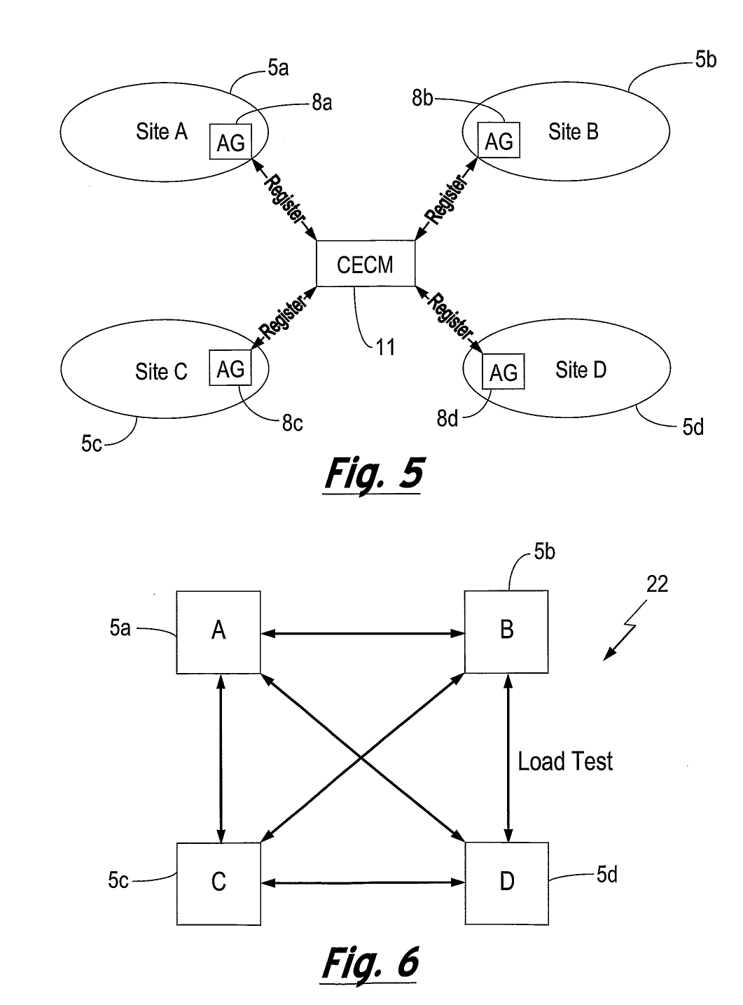

FIG. 5 presents a schematic diagram showing the deployment of application gateways 8a, 8b, 8c and 8d within the WAN 7 of FIG. 2. In the presently described example, only one static application gateway 8a, 8b, 8c and 8d within each site 5a, 5b, 5c and 5d, has been deployed although it should be appreciated that two or more static application gateways 8 could be deployed, for reasons of efficiency, within a large site 5. However, deploying only one application gateway 8a, 8b, 8c and 8d in each site 5a, 5b, 5c and 5d ensures that there shall only ever be one data stream entering of leaving each site 5a, 5b, 5c and 5d.

When a new application gateway registers with the CECM 11 it is preferable for an application gateway load test to be carried out on all of the registered application gateways, as described in detail within Stage 3 below. The time taken to perform the load test, Tₜₑₛₜ, is recorded within the CECM 11. Knowledge of the time taken to perform the most recent load test is a useful parameter for determining when the load test for the next collaboration session 6 should commence.

### Stage 2) Initiation of a Collaboration Session

The second stage of the process involves a user employing a client 10 to initiate the collaboration session 6. This involves the client 10 employed by the initiating user providing the session scheduler 14 with details for the collaboration session 6. These details include the time, T_{c}, of the collaboration session 6 and a list of invited users.

Upon receipt of this session request the session scheduler 14 allocates a session identifier and stores this identifier, along with the other details for the collaboration session 6, within the collaboration database 16. The session scheduler 14 then provides the session identifier and the details of the invited users, to the application gateways 8a, 8b, 8c and 8d within the sites 5a, 5b, 5c and 5d from which the users may access the collaboration session 6.

### Stage 3) Application Gateway Load or Throughput Testing

At a time Tₚ prior to when a collaboration session 6 is scheduled to begin, the load tester 21 initiates the performance of a load test or throughput test 22 on the application gateways 8a, 8b, 8c and 8d. As described in further detail below, the load test or throughput test is in the form of an analysis of the throughput capacities or speeds of the paths connecting the application gateways 8a, 8b, 8c and 8d. This test 22 is carried out close to the time T_{c} since it does not make sense to perform such a test days, or even hours, before T_{c}, since the network loading conditions will more often than not change within such time scales. The time Tₚ is therefore calculated from the following expression:

Tₚ=T_{c}−(Tₜₑₛₜ×C) (1)

where C is a factor introduced to provided an error margin for additional network loading having been introduced since the load test carried out at time Tₜₑₛₜ e.g. C=1.5.

The test 22 is employed to calculate the optimum data paths between the application gateways 8a, 8b, 8c and 8d for the collaboration session 6, in other words, how the application gateways 8a, 8b, 8c and 8d should interconnect for this particular collaboration session 6. It is done in a full-mesh manner as depicted schematically in FIG. 6. Importantly, the load tester 21 employs the path analyser 19 to measures the speed or throughput capacity of a predetermined quantity of data in both directions between each site 5a, 5b, 5c and 5d. It is preferable for the predetermined quantity of data to be at least 32 kb in size so as to provide the best results. The bidirectional measurement of the throughput capacity or speed is important for computing an efficient data path between the application gateways 8a, 8b, 8c and 8d, i.e. there is no assumption made that any given logical data path between the application gateways 8a, 8b, 8c and 8d supports the same bandwidth and latency in both directions. The reason for this may be due to the network infrastructure, network loading at a specific site or time, and even the way the Internet itself works, i.e. packets on a point-to-point connection do not necessarily take the same path. In other words, a packet sent from application gateway 8a to 8b may take a different path than a packet sent from application gateway 8b to 8a. Furthermore, where boundaries between different carriers are crossed, the routing may depend on the policy for CsC (Carrier supporting Carrier).

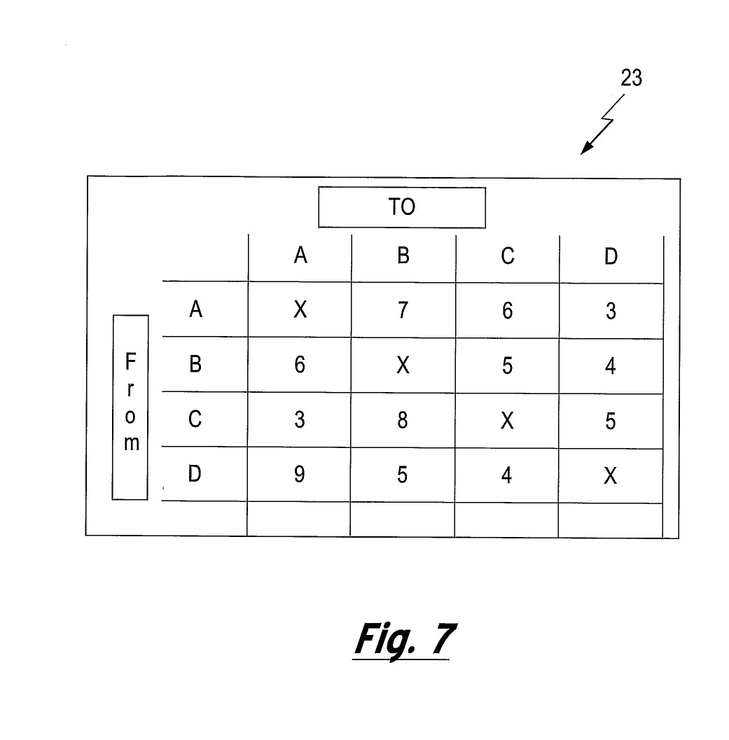

The results of the bidirectional testing of the connections between all of the application gateways 8a, 8b, 8c and 8d is then employed by the load tester 21 to generate a connectivity matrix of the throughput capacities or data path speeds (measured in kb/s) within the routing table 18. An example connectivity matrix 23 for the presently described collaboration session 6 is presented in FIG. 7. The value ‘x’ denotes either no connectivity, or links that have already been established and are therefore no longer considered.

In order to allow for computation of the optimised data path, it is beneficial for the connectivity matrix to be normalised. That is to say, that if connection A→B is, for example, 100 kb/s, and connection A→C is 105 kb/s, then these are to be viewed as ‘similar’. Normalisation of the connectivity matrix is achieved by applying the following equation to each of the cells C of the connectivity matrix 23, namely:

C=round(10*t/T) (2)

where
t is the measured throughput capacity or data path speed for cell C; and
T is the highest measured throughput capacity or data path speed for any of the cells of the connectivity matrix.

As a result of the above normalisation process all of the values within the matrix are expressed relative to the highest measured throughput capacity or data path speed. Thus, the highest measured throughput capacity or data path speed is assigned the number 10 while the other connections are effectively graded from 0 to 10.

Normalisation ensures that connections which only slightly differ in their measured throughput capacities or speeds are regarded as having the same throughput capacity or speed. Without normalisation a “chaining effect” can occur whereby the data path tends to grow in depth (hop count) rather than breadth which results in more end-to-end delay and sub-optimal data transmission.

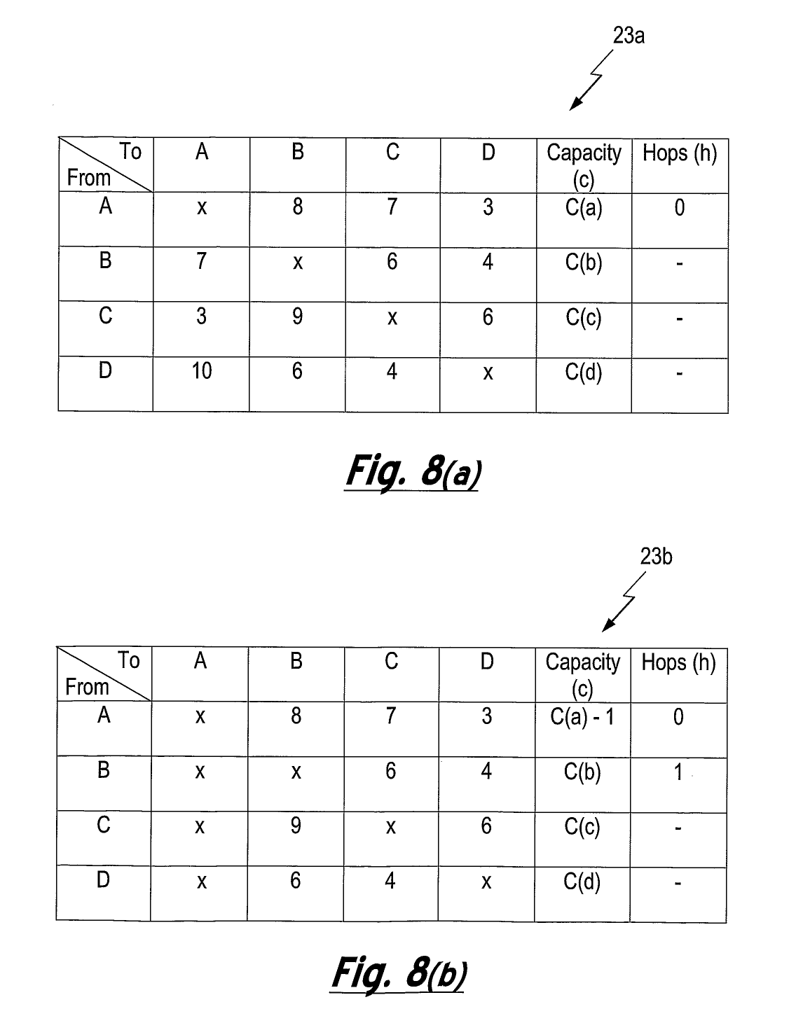

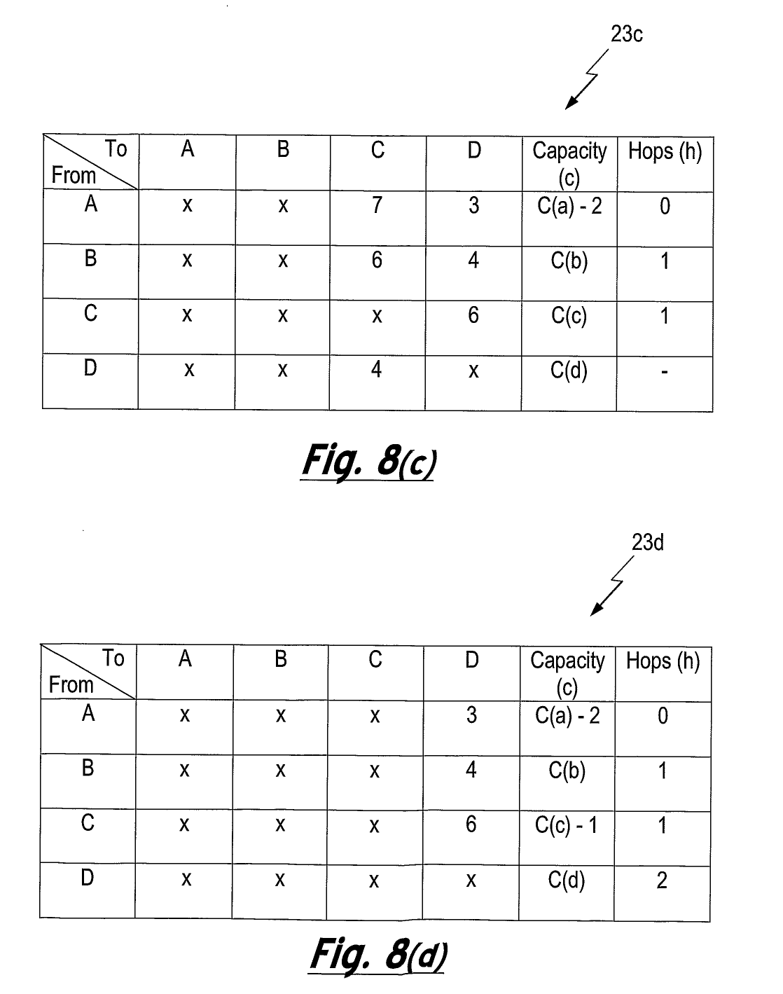

A normalised connectivity matrix 23a for the presently described collaboration session 6 is presented in FIG. 8(a). The sixth and seventh columns of the normalised connectivity matrix 23a relate to the capacity “c” of the application gateways 8a, 8b, 8c and 8d and the number of hops “h” the application gateway 8a, 8b, 8c and 8d is from the sub-network within which the server 9 is located, respectively. Further details of these two parameters are discussed below.

The next stage in the load testing 22 process is the need to convert the normalised connectivity matrix 23a of FIG. 8a to an optimised data path between the application gateways 8a, 8b, 8c and 8d within the WAN 7 of FIG. 2. This is achieved by the load tester 21 employing the following algorithm or methodology to manipulate the normalised connectivity matrix 23a stored within the routing table 18, namely:
Start with a normalised connectivity matrix From: To containing n rows (and thus n+2 columns).
The source is located at x.
Source set Y is {x}
Out-of-capacity set X is { }
Repeat
Blank out the columns in {Y}
Find the largest value from source set {Y} but not in X to a node ‘b’ which is not in {Y}
If there are multiple possibilities, choose ‘a’ such that a(h) is smallest
If there are multiple possibilities, choose ‘a’ such that a(c) is largest
Result is source ‘a’, target ‘b’
Decrement a(c) by one
Assign b(h)=a(h)+1
If a(c)=0, then add ‘a’ to X as it can no longer be a source
Add node ‘b’ to {Y}, i.e. target ‘b’ is now another source
Until O({Y})=n

It will be appreciated that the further an application gateway 8 is from the data source i.e. the server 9, in terms of the hop count, the more delay the clients 10 connected to that application gateway 8 will experience. Thus, in order to take increasing delay into account the above algorithm tracks the number of source hops “h” an application gateway 8 is away from the data source. The source application gateway 8 is allocated the value of 0.

Furthermore, once an application gateway 8 makes a connection its capacity to service additional connections is reduced. In order to take the reduced ability to service additional connections into account the above algorithm also reduces the inherent capacity “c” of each application gateway 8 by one each time a connection from that application gateway 8 is established. Once an application gateway 8 runs out of capacity it is added to an out of capacity set X.

As a result, when another application gateway 8 is to be connected, and there are two or more possibilities in terms of throughput capacities or data path speeds, the algorithm first considers the number of source hops “h” the connecting application gateway 8 is away from the data source. The connecting application gateway 8 with the lowest source hop count is chosen in preference to any other. However, if there are two or more possible application gateways 8 with the same hop count then the algorithm selects the one which exhibits the largest available capacity at that time.

By employing the above techniques relating to source hops and capacity availability ensures that the data distribution tree will grow ‘wider’ rather than ‘deeper’, thus minimising the end-to-end delay.

FIGS. 8(b) to (d) present the implementation of the above algorithm or methodology to the normalised connectivity matrix 23a. Since in this example the server 9 is located in site 5a (site A) this means that the optimised data path must be produced with site 5a as the root i.e. source set Y is {A}. In accordance with the above discussion, the hop value for site 5a (site A) is allocated the value of 0. Since site 5a (site A) does not need to connect to itself the From→To column of A can be voided. These steps result in a revised connectivity matrix 23b as presented in FIG. 8(b).

The next step requires finding an optimal link from the source site 5a (site A) to a destination. The connectivity matrix 23b yields that the most efficient link from 5a (site A) is to site 5b (site B). We have therefore found a link A→B which is optimal, and the source set is updated to be Y is {A, B}. Since B is now connected, it is removed from the set of possible targets, resulting in a revised connectivity matrix 23c as presented in FIG. 8(c). It should be noted that the capacity of site 5a (site A) has been reduced by one while site 5b (site B) is indicated as being one hop from the data source.

Now, given the source set Y is {A, B}, the highest value to a target is sought by looking at both sources, and taking account of any application gateway which may now be out of capacity. FIG. 8(c) reveals that the highest value is from A→C. Again, a new source has been found and the connection A→C is made. The revised source set is now {A, B, C} and the revised connectivity matrix 23d is as presented in FIG. 8(d). The capacity of site 5a (site A) is now reduced by two while site 5c (site C) is indicated as being one hop from the data source.

The process repeats once more since O({A, B, C})<O(nodes). However, now there is only one node, D, unconnected, and a glance at the matrix 23d reveals that the best available connection is C→D. The capacity of site 5c (site C) is therefore reduced by one while site 5d (site D) is indicated as being two hops from the data source.

The source set Y is now {A, B, C, D} and thus the optimisation method is complete and the routing table 18 is updated, as appropriate.

It should be noted that when computing the data path, the above algorithm, and hence the routing table 18 takes into account the location of the server 9 i.e. the source of the actual data. In the above example the server 9 was located in site 5a (site A), however the final data path structure would have been quite different if the server 9 had been located, for example, in site 5d (site D).

### Stage 4) Clients and Server Join the Collaboration Session

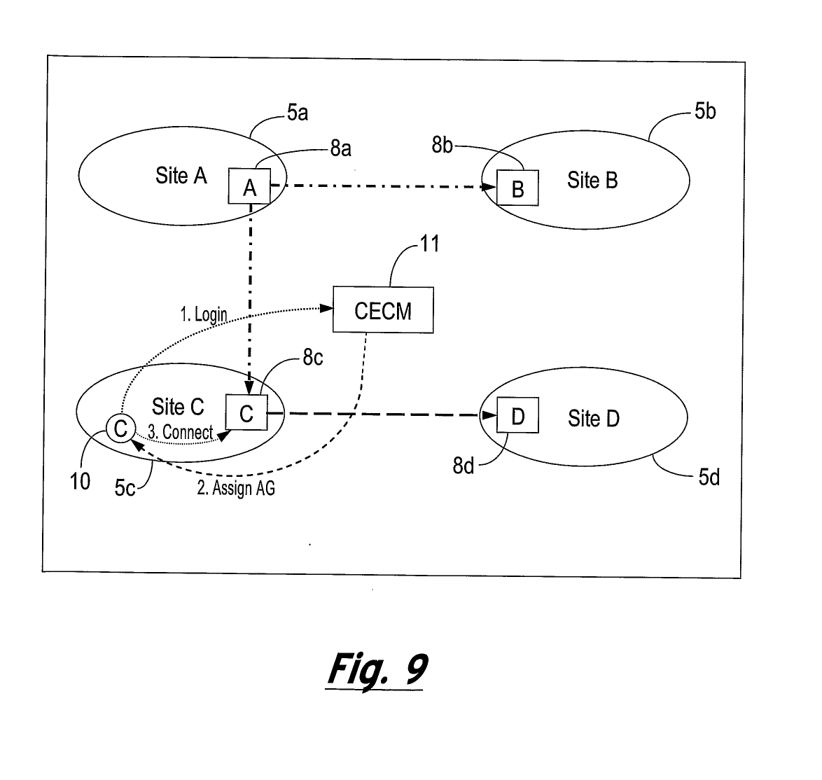

When the server 9 and clients 10 wish to join the scheduled collaboration session 6, they do so by contacting the CECM 11, as presented schematically in FIG. 9. The server 9 and client 10 must supply a valid session ID as well as a valid user name and password. The CECM 11 then employs the user authentication module 15 to validate the server 9 and client's 10 credentials and then checks to see whether the users of the server 9 and client 10 have the required permission to join the collaboration session 6.

If the users of the server 9 and client 10 have the required permission then the session scheduler 14 supplies a server and client identifier and details of the appropriate application gateways, 8a and 8c, to the server 9 and client 10, respectively, for them to join the session 6. The allocated application gateway is preferably chosen to be the one determined by the CECM 11 to be able to supply the highest data throughput rate to the server 9 or client 10, although an alternative application gateway specifically optimised for that client may be selected (see the discussion below regarding dynamic application gateways). The server 9 and the clients 10 are therefore able to join the session 6 by connecting via the assigned application gateway 8c.

If at the time a client 10 attempts to join the collaboration session 6 a check (Stage 5) is made to see if the server 9 has already joined the session 6. If the sever 9 has not yet joined the CECM 11 informs the client 10 that the presenter is not yet available (Stage 6). Once the server 9 joins the session 6 the CECM 11 informs the clients 10 and then the session 6 commences (Stage 7). In this way the CECM 11 acts as a virtual lobby for clients 10 in the absence of the server 9.

Data Routing within the Collaboration Session

For a collaboration session 6 it must be possible to grant session control to an individual client 10. Conversely, it must be possible for a client 10 to send data upstream to the server 9. Examples of such data flows would be session control requests, file upload requests or white boarding. Thus the presently described architecture is capable of allowing data within the collaboration session 6 to be routed between:
1) the server 9 and all clients 10;
2) the server 9 and individual clients 10;
3) a client 10 and the server 9;
4) a client 10 and another client 10; and
5) a client 10 and multiple selected clients.

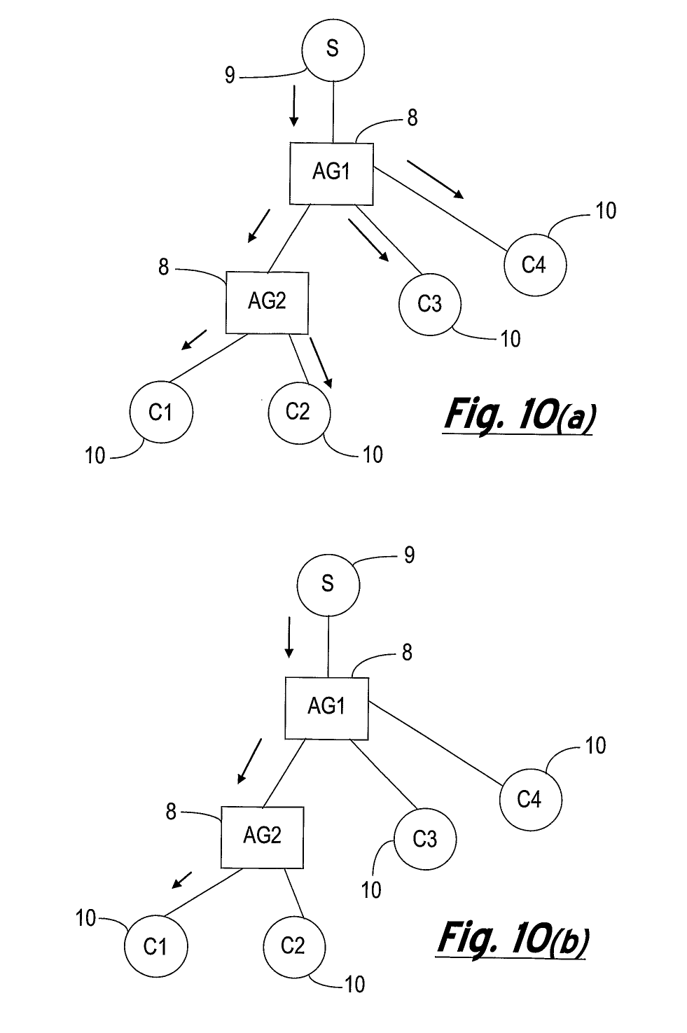

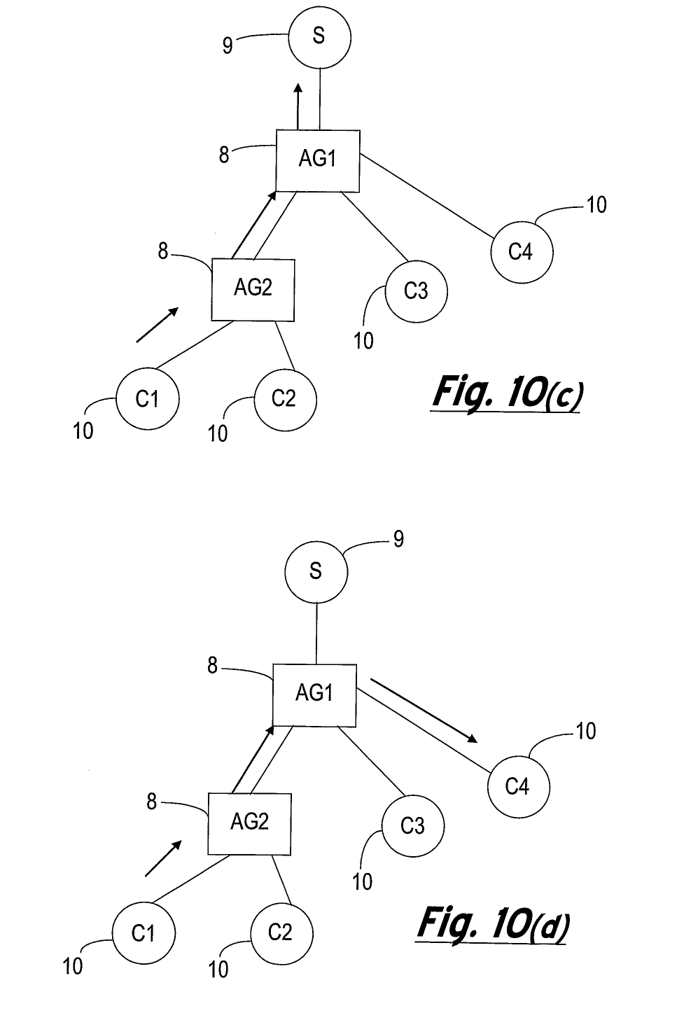

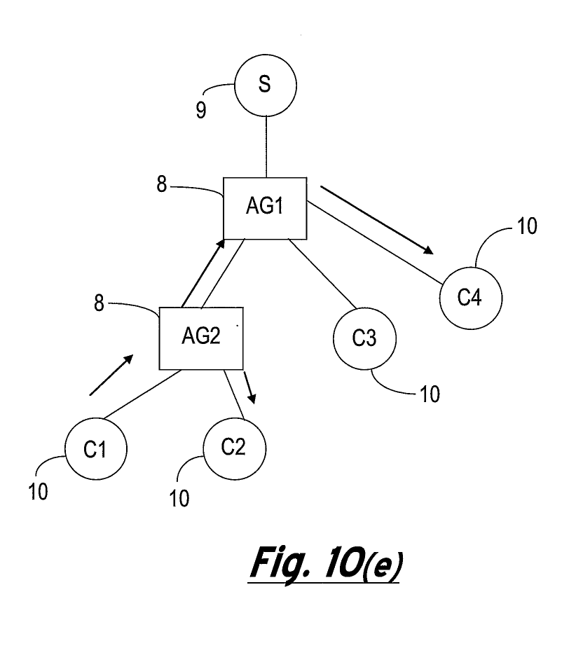

Schematic representations of these data routes are presented in FIG. 10.

This functionality is achieved in the presently described collaboration session 6 by employing a routing method that is based on routing tables stored within the application gateways 8 and the employment of bespoke protocol headers.

Since every client 10 has a client identifier and the server 9 a server identifier, as assigned by the CECM 11, each application gateway 8 has a mapping from the client and server identifiers to logical links. In other words, each application gateway 8 can determine which logical link a given data packet is to be sent out on.

A TCP/IP protocol header contains a source and destination field, amongst other data. There are two predefined values for the destination field. These are SERVER and ALL. So, any message which has SERVER in the destination field will be sent to the collaboration server 9 and any message with ALL in the destination field is sent to all the clients 10.

The source field is always the assigned identifier of the sender.

Exploiting the destination field therefore provides the means for the required routing within the collaboration session 6 since any message which has an actual client identifier as the destination field, will be routed directly to that client 10. Alternatively, multiple client identifiers may be entered within the destination field to allow data to be routed to more than one client 10.

It should be noted that the employment of the CECM 11 also allows the clients 10 to be network agnostic. For example, the client 10 does not need to know the IP address of the data source i.e. the server 9. An example of this could be a scheduled session 6 where the presenter is in a hotel and cannot possibly know his own address a priori. A client 10 simply requires knowledge of the session ID. They then connect to the collaboration session 6 by contacting the well known IP address of the CECM 11.

A further point to note is that after the client 10 has joined the collaboration session 6 the CECM 11 has no further interaction with the client 10 and so it is not involved in any further communication process. As a direct consequence the functionality of the CECM 11 is implemented within the Session Layer (layer five) of the Open Systems Interconnection Reference Model (OSI Reference Model). This is in comparison with the known Application Layer Multicast systems whose implementation resides within layer seven of the OSI Reference Model.

### Dynamic Application Gateways

Although statically deployed application gateways 8a, 8b, 8c and 8d significantly reduce the bandwidth required to interconnect sites 5a, 5b, 5c and 5d, it may be possible for a site 5a, 5b, 5c and 5d to have too many clients 10 for it to support. As discussed previously, in such circumstances a second static application gateways 8, if available, may be deployed within that site 5a, 5b, 5c and 5d. However, this may not be practical in all cases.

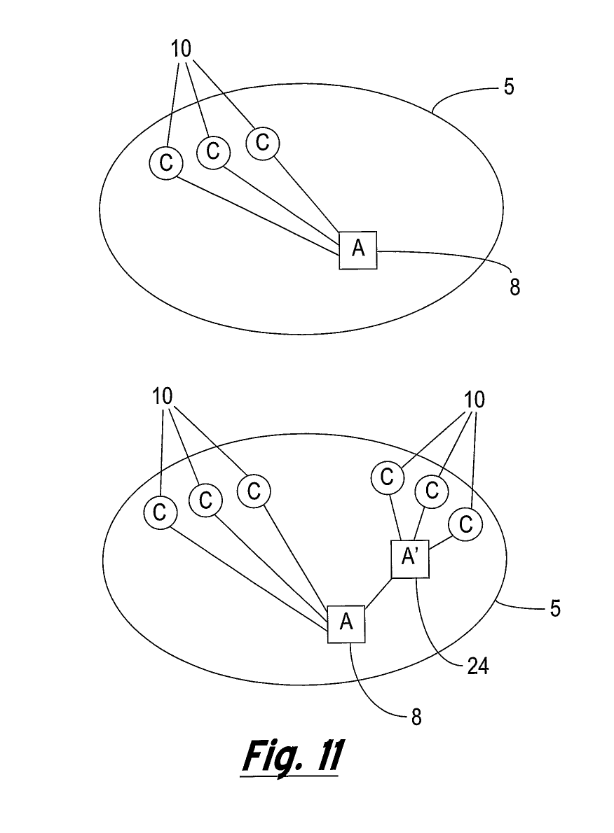

An alternative solution is to employ dynamic application gateways, as will now be described with reference to FIG. 11. A static application gateways 8 may at any point signal to the CECM 11 via the application gateway interface 20 that its client-handling capabilities have, or are about to be, exhausted. From the above described process for the selection of application gateways, the CECM 11 will know whether or not a second static application gateway 8 exists within the site 5. If this is not the case, and should another client 10 within the site 5 wish to connect to the collaboration session 6, then the CECM 11 will ask that client 10 to act as a dynamic application gateway 24. Any further client 10 within the site 5 wishing to join the collaboration session 6 will then be connected via the dynamic application gateway 24.

It will be appreciated that this process can be extended when the first dynamic application gateway 24 has, or is about to, exhaust its own client handling capabilities. At this time a second dynamic application gateway (not shown) is established by the CECM 11.

In the absence of the dynamic application gateways 24, the static application gateways 8 would have to serve six separate clients 10. However, upon establishing the dynamic application gateways 24 the static application gateways 8a now effectively only has to serve three separate clients 10 and the dynamic application gateways 24, the three remaining clients 10 are now served directly by the dynamic application gateways 24.

This mechanism allows for the dynamic management of traffic within the sites 5a, 5b, 5c and 5d i.e. the required bandwidth can be managed and minimised. As can clearly be seen from FIG. 11, the load and bandwidth on the static application gateways 8 has been reduced from what would be six to four. Within large sites 5a, 5b, 5c and 5d this approach will readily scale, since more dynamic application gateways 24 can be created on demand.

### Dynamic Collaboration Session

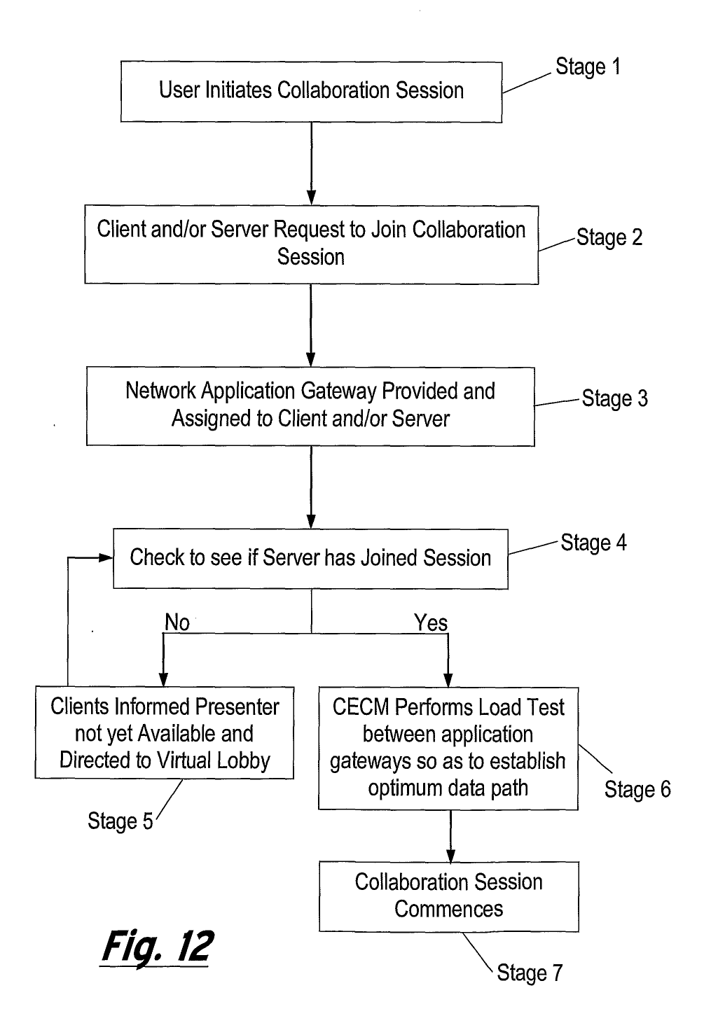

It will be appreciated that an alternative methodology for establishing the collaboration session 6 may involve the employment of only dynamic application gateways. The methodology for this embodiment will now be described with reference to FIG. 2 and the flow chart presented in FIG. 12.

In this embodiment the first stage involves a user employing a client 10 to initiate the collaboration session 6. This again involves the client 10 employed by the initiating user providing the session scheduler 14 with details for the collaboration session 6. These details include the time, T_{c}, of the collaboration session 6 and a list of invited users. Upon receipt of this session request the session scheduler 14 allocates a session identifier and stores this identifier, along with the other details for the collaboration session 6, within the collaboration database 16. The session scheduler 14 then provides the session identifier and the details of the invited users, for example by sending an appropriate e-mail.

When a client 10 wishes to join the scheduled collaboration session 6, they do so by contacting the CECM 11 (Stage 2), as presented schematically in FIG. 9. The client 10 must supply a valid session ID as well as a valid user name and password. The CECM 11 then employs the user authentication module 15 to validate the client's 10 credentials and then checks to see whether the user of the client 10 has the required permission to join the collaboration session 6.

If the user has the required permission then the session scheduler 14 supplies a client identifier and details of the appropriate dynamic application gateway (Stage 3), 8c, to the client 10 for them to join the session 6. If the client 10 is the first terminal within a particular network to contact the CECM 11 then it is instructed to act as the dynamic application gateway, as described in detail above.

The allocation of subsequent dynamic application gateways is preferably chosen to be the one determined by the CECM 11 to be able to supply the highest data throughput rate to the client 10. If however, the client handling capacity of this dynamic application gateway has been reached then a subsequent client 10 will be instructed by the CECM 11 to act as a further dynamic application gateway. The clients 10 are therefore able to join the session 6 by connecting via the assigned dynamic application gateway 8a to 8d.

If at the time a client 10 attempts to join the collaboration session 6 a check is made to see if the server 9 has already joined the session 6 (Stage 4). If the sever 9 has not yet joined the CECM 11 informs the client 10 that the presenter is not yet available and the CECM 11 acts as a virtual lobby for the clients 10 in the absence of the server 9 (Stage 5).

In this embodiment, the request by the server 9 to join the collaboration session 6 is similar to that previously described. The making of this request is also the activation for the CECM 11 to perform the load test 22 on the dynamic application gateways 8a, 8b, 8c and 8d so optimise the data communication paths between them (Stage 6). The methodology for the load test 22 is that as previously described.

Once the server 9 is present, and the load test 22 has been performed, the collaboration session 6 can commence (Stage 7). It should be noted that if a client 10 submits a request to join the collaboration session 6 after it has commenced then it is simply allocated dynamic application gateways 8a, 8b, 8c and 8d as previously described once the user's identification has been verified.

If, however, a subsequent dynamic application gateway is required, say for example because the client is based within a LAN not presently participating in the collaboration session 6, then a modified load test is performed to determine how the new gateway should connect to the presently connected optimised dynamic application gateway network. This modified load test involves measuring the throughput capacity or speed to each of the presently existing dynamic application gateways and connecting the new gateway to that path having the highest throughput value.

If there are two or more possibilities in terms of throughput capacities or speeds, then the number of source hops “h” the connecting dynamic application gateway 8 is away from the data source is considered. The connecting dynamic application gateway 8 with the lowest source hop count is chosen in preference to any other. However, if there are two or more possible dynamic application gateways 8 with the same hop count then the one which exhibits the largest available capacity at that time is selected.

An important point to note is that once the load test or throughput test has been performed and the optimised connection of the application gateways (static or dynamic) has taken place the structure of the application gateway network remains constant for the duration of the collaboration session. Further dynamic application gateways may be added but this is done in such a way so as not to disrupt communication paths within the originally optimised application gateway network. Disruptions within communication paths, however short, lead to broken connections such that any ongoing file transfer would require to be restarted from the beginning.

The above described network-based collaboration provides a system that is secure, that ensures for reliable data delivery within the system, and which is readily scalable so as to allow for use by hundreds of clients. In addition, the system provides any client within the collaboration session with the capability of sending selected data directly to any other selected individual client or clients.

It is the employment of the application gateways that solves the problem of requiring multiple connections in and out of a site. Since data flowing from the host client is the same for all clients, it is not necessary to have multiple data streams. Data is thereafter redistributed within the LAN of a site, thereby greatly reducing the required bandwidth on the WAN. Since the bandwidth available within a LAN is much greater than across the WAN, this approach eliminates the effects of performance bottlenecks between sites.

The data pathways between the application gateways are then optimised by the employment of a pre-session, source-specific load test. The load test bidirectionally measures both the latency and the throughput capacity between all of the application gateways so as to provide a means for computing a bandwidth saving distribution path between these gateways.

One significant advantage of the reduced bandwidth requirements within the network is that it allows for the employment of a secure and reliable data communication protocol within the network e.g. a transmission control protocol/Internet protocol (TCP/IP). Such data security and reliability is important in providing a robust collaboration system.

The employment of static and dynamic application gateways also provides the described collaboration session with a significant degree of flexibility and scalability when compared with the known prior art systems.

A yet further advantage of the presently described system is that the functionality of the collaboration establishing control module is implemented with the Session Layer (layer five) within the OSI model and not the Application Layer (layer seven). This is possible because the CECM handles all of the management functions that are required to build, initiate and maintain the collaboration session. Significantly though, this is achieved without the CECM being actively involved in the session itself. As a result there is a significant reduction in the complexity of the presently described system, allowing the creator to focus on functionality rather than infrastructure. This provides obvious time and resource savings when compared to those systems implemented within the Application Layer.

The foregoing description of the invention has been presented for purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims. The invention also extends to combinations of features other than those expressly claimed herein.

1. A method of performing a collaboration session in a network, the method comprising the steps of:
providing a server-terminal as a data source for the collaboration session;
providing a plurality of client-terminals, each client-terminal providing a user with an access point for participating in the collaboration session; and
providing two or more application gateways, each application gateway configured to relay data between network components during the collaboration session;
wherein the server-terminal is provided with a server application gateway to which it transmits data during the collaboration session, the server application gateway determined according to the server-terminal location; and
each client-terminal is provided with a client application gateway from which it receives data during the collaboration session, each client application gateway determined according to the client-terminal location.

2. A method of performing a collaboration session as claimed in claim 1 wherein the method comprises the additional step of employing a single application gateway as both a server application gateway and a client application gateway.

3. A method of performing a collaboration session as claimed in claim 1 wherein the method comprises the additional step of employing different application gateways as a server application gateway and a client application gateway.

4. A method of performing a collaboration session as claimed in claim 1 wherein method comprises the additional step of employing multiple client application gateways within the network to which respective client-terminals are allocated.

5. A method of performing a collaboration session as claimed in claim 1 wherein the method comprises the additional step of employing a first client application gateway to relay data to a second application gateway, which then relays data to respective client-terminals.

6. A method of performing a collaboration session as claimed in claim 1 wherein the method comprises the additional step of allocating an application gateway to a server-terminal for the duration of the collaboration session.

7. A method of performing a collaboration session as claimed in claim 1 wherein the method comprises the additional step of allocating an application gateway to each of the plurality of client-terminals for the duration of the collaboration session.

8. A method of performing a collaboration session as claimed in claim 1 wherein the step of providing the one or more application gateways comprises deploying one or more static application gateways.

9. A method of performing a collaboration session as claimed in claim 8 wherein the application gateways are deployed to provide an optimum data transfer speed or throughput capacity to an associated sub-network of identified client-terminals.

10. A method of performing a collaboration session as claimed in claim 1 wherein the step of providing the one or more application gateways comprises deploying one or more of the identified client-terminals as one or more dynamic application gateways.

11. A method of performing a collaboration session as claimed in claim 10 wherein the one or more identified client-terminals selected to be deployed as the one or more dynamic application gateways are chosen to provide an optimum data transfer speed or throughput capacity to an associated sub-network of identified client-terminals.

12. A method of performing a collaboration session as claimed in claim 1 wherein the step of providing the server terminal with a server application gateway is performed by a collaboration establishing control module.

13. A method of performing a collaboration session as claimed in claim 12 wherein the collaboration establishing control module performs the step of providing the client-terminal with a client application gateway.

14. A method of performing a collaboration session as claimed in claim 12 wherein the collaboration establishing control module comprises a web server.

15. A method of performing a collaboration session as claimed in claim 14 wherein the web server enables communication between the collaboration establishing control module and the plurality of client-terminals and/or the server-terminal.

16. A method of performing a collaboration session as claimed in claim 12 wherein the collaboration establishing control module further comprises a collaboration database employed to retain information about the collaboration session.

17. A method of performing a collaboration session as claimed in claim 12 wherein the collaboration establishing control module to further comprise a daemon that enables the implementation of background run functions for the collaboration session.

18. A method of performing a collaboration session as claimed in claim 12 wherein the collaboration session is initiated by a user submitting a collaboration session request to the collaboration establishing control module.

19. A method of performing a collaboration session as claimed in claim 18 wherein the session request comprises details of the identities of the participating users of the collaboration session.

20. A method of performing a collaboration session as claimed in claim 18 wherein the session request comprises a scheduled time, T_{c}, for the collaboration session.

21. A method of performing a collaboration session as claimed in claim 18 wherein a session identifier is allocated to the collaboration session following the submission of the collaboration session request.

22. A method of performing a collaboration session as claimed in claim 1 wherein the server-terminal is located outside of an associated sub-network of identified client-terminals.

23. A method of performing a collaboration session as claimed in claim 1 wherein the method further comprises the step of performing a load test or throughput test on two or more application gateways.

24. A method of performing a collaboration session as claimed in claim 23 wherein the load test is performed by the collaboration establishing control module.

25. A method of performing a collaboration session as claimed in claim 23 wherein the load test is carried out a predetermined time, Tₚ, prior to the scheduled time, T_{c}, for the collaboration session.

26. A method of performing a collaboration session as claimed in claim 25 wherein the predetermined time, Tp is determined by the following expression Tₚ=T_{c}−(Tₜₑₛₜ×C) where Tₜₑₛₜ is a time taken to perform a previous load test on the collaboration network and C is an error margin factor.

27. A method of performing a collaboration session as claimed in claim 26 wherein the error margin factor C has a value greater than one.

28. A method of performing a collaboration session as claimed in claim 12 wherein the method further comprises the step of each participating client submitting a user registration request to the collaboration establishing control module.

29. A method of performing a collaboration session as claimed in claim 12 wherein the method further comprises the step of a server submitting a user registration request to the collaboration establishing control module.

30. A method of performing a collaboration session as claimed in claim 29 wherein the method further comprises the step of a load test or throughput test being performed after the server submits a user registration request to the collaboration establishing control module.

31. A method of performing a collaboration session as claimed in claim 28 wherein the user registration request is required to comprise a valid session identifier, a valid user name and password in order for the participating client or server to register with the collaboration session.

32. A method of performing a collaboration session as claimed in claim 31 wherein the user registration request is checked by the collaboration establishing control module to establish whether or not the user has the required permission to join the collaboration session.

33. A method of performing a collaboration session as claimed in claim 32 wherein if it is established that the user has the required permission then the method further comprises the step of the client being allocated a client identifier.

34. A method of performing a collaboration session as claimed in claim 1 wherein the method further comprises the step of an application gateway providing an indication that a client handling capability of the application gateway is, or is about to be, exhausted.

35. A method of performing a collaboration session as claimed in claim 34 wherein when a further valid user registration request is received from a client within the associated sub-network the client-terminal submitting the request is instructed to function as a first sub-network dynamic application gateway.

36. A method of performing a collaboration session as claimed in claim 35 wherein the method further comprises the step of the first sub-network dynamic application gateway providing an indication that a client handling capability of the first sub-network dynamic application is, or is about to be, exhausted.

37. A method of performing a collaboration session as claimed in claim 36 wherein when a further valid user registration request is received from a client within the associated sub-network the client-terminal submitting the request is instructed to function as a second sub-network dynamic application.

38. A method of performing a collaboration session as claimed in claim 1 wherein the method further comprises the step of one of the plurality of clients selectively transmitting data to the server and/or one or more of the other plurality of clients.

39. A method of performing a collaboration session as claimed in claim 38 wherein the step of selectively transmitting data comprises the transmission of data to the client application gateway and the subsequent relaying of this data by the client application gateway to the server-terminal and/or the one or more of the plurality of client-terminals.

40. A method of performing a collaboration session as claimed in claim 1 wherein the server-terminal and the server application gateway are located within a first sub-network.

41. A method of performing a collaboration session as claimed in claim 40 wherein the client application gateway and at least one of the plurality of client-terminals is located within a second sub-network.

42. A method of performing a collaboration session as claimed in claim 41 wherein the network comprises a wide area network and the first and second sub-networks comprise local area networks.

43. A method of performing a collaboration session as claimed in claim 1 wherein the step of transmitting and relaying data comprises the employment of a transmission control protocol/Internet protocol (TCP/IP).

44. A network system for hosting a collaboration session the system comprising:
a server-terminal providing a source for data in the collaboration session;
a plurality of client-terminals, each providing a user with an access point for participating in a collaboration session; and
two or more application gateways each application gateway configured to relay data between network components during a collaboration session;
wherein the server-terminal is provided with a server application gateway to which it transmits data during the collaboration session, the server application gateway determined according to the server-terminal location; and
each client-terminal is provided with a client application gateway from which it receives data during the collaboration session, each client application gateway determined according to the client-terminal location.

45. A network system as claimed in claim 44 wherein a single application gateway functions as both a server application gateway and a client application gateway.

46. A network system as claimed in claim 44 wherein a server application gateway and a client application gateway comprise different application gateways.

47. A network system as claimed in claim 44 wherein the system comprises multiple client application gateways in the network, to which are allocated respective client-terminals.

48. A network system as claimed in claim 44 wherein the system comprises a first client application gateway to relay data to a second application gateway, which then relays data to respective client-terminals.

49. A network system as claimed in claim 44 wherein the network system further comprises a collaboration establishing control module.

50. A network system as claimed in claim 49 wherein the collaboration establishing control module comprises a web server.

51. A network system as claimed in claim 50 wherein the web server enables communication between the collaboration establishing control module and the plurality of client-terminals and/or the server-terminal.

52. A network system as claimed in claim 49 wherein the collaboration establishing control module further comprises a collaboration database employed to retain information about the collaboration session.

53. A network system as claimed in claim 49 wherein the collaboration establishing control module further comprises a daemon that enables the implementation of background run functions for the collaboration session.

54-69. (canceled)

70. A computer apparatus loaded with machine readable instructions for implementing a method of performing a collaboration session in a network as claimed in claim 1.

71. (canceled)
